(19) United States
(12) Patent Application Publication
(10) Pub. No.: US 2024/0041262 A1
(43) Pub. Date: Feb. 8, 2024

(54) Flow Generator, Food Processor and Method

(71) Applicant: Vorwerk & Co. Interholding GmbH, Wuppertal (DE)

(72) Inventors: Peter Lakshmanan, Dortmund (DE); Felix Haunschild, Essen (DE); Kevin Schmitz, Haan-Gruiten (DE)

(21) Appl. No.: 18/227,050

(22) Filed: Jul. 27, 2023

(30) Foreign Application Priority Data
Aug. 2, 2022 (EP) 22 188 243.4

(51) Int. Cl. A47J 43/07; A47J 43/046; A47J 43/08; A47J 27/00

(52) U.S. Cl. CPC A47J 43/0722; A47J 43/046; A47J 43/085; A47J 27/004

(57) ABSTRACT

The invention relates to a food processor (300) for preparing at least one food product (10), comprising a drive (330) configured to set at least one preparation tool (100, 400) in motion, a preparation tool (100) configured as a flow generator (100) for flowing air in the vessel (320) towards the at least one food product (10), a vessel (320) configured to contain the at least one food product (10), the vessel (320) comprising a vessel heater (310) configured to heat the air enclosed in the vessel (320), wherein the vessel heater (310) is integrated in a bottom of the vessel (320). Furthermore, the invention relates to a method of operating a food processor (300).

The invention relates to a food processor and a method of operating a food processor.

A large number of kitchen appliances are known from the prior art, which can perform various tasks such as chopping, kneading, stirring, juicing, heating, cooling, pressing into shape, etc.

Often a device fulfills a special function or allows food products to be processed according to a special method. For example, pasta machines are known for producing shaped pasta from dough, bread baking machines for baking bread or fryers for frying food products.

Especially the combination of a base device, which is electrically operated, and a vessel, in which food products can be picked up and processed, allows the user to process food products without having to hold the device or the food product in his hand. Such devices are also known as food processors.

To further simplify food product preparation for users, it would be desirable if fewer devices had to be used and, in addition, handling was simplified.

Among the preparation methods, deep frying, also known as deep-fat frying, is a variant that can be carried out in principle in a pot with liquid fat or oil. The fat is heated to a relatively high temperature in order to cause a Maillard reaction, which results in a dry crust and aromatic roasting substances on the food product to be processed. However, the high temperature can increase the risk of injury. Furthermore, uncontrolled, intense heating of the fat can result in the formation of substances that are harmful to health.

It is an object of the present invention to at least partially eliminate the aforementioned disadvantages known from the prior art. In particular, it is an object of the present invention to provide a food processor as well as a method for operating a food processor, in which an improved user experience and/or an increased range of functions is ensured when processing food products. In addition, the safety of the user should preferably be ensured and the devices should be cost-efficient to manufacture and operate.

The foregoing problem is solved by a food processor having the features of the independent device claim and a method having the features of the independent method claim. Further features and details of the invention result from the respective dependent claims, the description and the drawings. Features and details described in connection with the food processor according to the invention naturally also apply in connection with the method according to the invention and vice versa in each case, so that reference is or can always be made mutually with regard to the disclosure concerning the individual aspects of the invention.

According to a first aspect of the invention, there is provided a food processor for preparing at least one food product, comprising a drive configured to set at least one preparation tool in motion, a preparation tool configured as a flow generator for flowing air in the vessel towards the at least one food product, a vessel configured to contain the at least one food product, the vessel comprising a vessel heater configured to heat the air enclosed in the vessel, the vessel heater being integrated in a bottom of the vessel.

The term “flowing” refers to the provision of moving air (which can also include a mixture of air) which flows against or around the food product. The flow can be laminar, turbulent or different within the flow field. Depending on which food products are arranged in the vessel and in what way, the flow field can change accordingly.

In the context of the invention, food products are to be understood as all substances that can be consumed by humans (or animals) for nutritional purposes. In particular, the food products may be deep fryable, i.e., fryable food products. Thereby, in general, almost all food products are fryable as long as they have a certain firmness.

The term “air” is to be understood as the gas mixture present in the environment of the flow generator. As a rule, this will be normal ambient air. However, it is also conceivable that the air is at least a predetermined gas mixture or has a predetermined pressure, in particular a pressure that differs from atmospheric pressure. In this way, the baking process can be specially configured and optimized to the food product.

A vessel, or container, in the sense of the invention can be a spatially shaped object which is designed/configured to hold at least one food product. The heatability of the vessel is to be understood as the suitability of the vessel to be heated. Depending on the particular embodiment of heating, the requirement may be different. For example, it may be provided that at least a portion of the vessel is formed of materials that can withstand a temperature of at least 100° C., preferably 200° C. or 220° C. Furthermore, the shape of the vessel can be designed/configured in such a way that at least one heater can be accommodated in the vessel or the thermal contact with the heater can be improved, in particular by surfaces lying flat on top of each other. Further details on properties of the vessel are described below.

The vessel heater can be designed/configured to heat the air to a temperature of at least 180° C., in particular at least 200° C. It can also be provided that the vessel heater is designed/configured to heat the air to a temperature between 50° C. and 230° C.

As mentioned above, the vessel has a vessel heater configured to heat the air enclosed within the vessel, wherein the vessel heater is integrated into a bottom of the vessel. In other words, the vessel may have a heat source configured to heat the air contained within the vessel. This offers the advantage that the vessel heater can be used even if a further preparation tool is connected to the drive instead of the flow generator.

By integrated it can be understood in particular that an active component of the heater, for example an electrical resistance heater, in particular in the form of a heating coil, a microwave antenna and/or a radiation source, is not in direct contact with the interior of the vessel, but is separated from the interior, in particular hermetically, at least by a layer which at least partially forms the vessel bottom. The integration, in particular hermetic sealing, of the heater within the vessel bottom offers the advantage that the entire vessel can be easily cleaned with water, in particular in a dishwasher, which simplifies the handling of the food processor.

The heater may be designed/configured as a thick-film heater. This type of heater has the advantage that it can be installed in a particularly space-saving manner and also offers good heat conduction.

It is also possible for the heater to be designed/configured as a tubular heater, in particular one that is at least partially integrated or encapsulated. A tubular heater can transmit high heat flows particularly well and is very robust against thermal and mechanical stress. In the case of at least partial integration, contact with the at least one food product is reduced, so that fewer or no deposits can form. In an encapsulated design/configuration, no deposits can form on the heater.

The vessel bottom can have a steel, in particular stainless steel, copper and/or an electromagnetically at least partially transparent material, which is arranged in the area of the active component. Metals offer particularly good heat conduction properties, which means that the air in the vessel can be heated quickly. An electromagnetically at least partially transparent material can be penetrated by microwaves and/or infrared radiation, enabling particularly effective heating of the air in the vessel by means of microwaves and/or infrared heaters.

The arrangement of the vessel heater at the bottom of the vessel offers the advantage that the heat (due to convection) can be transmitted particularly well to the air and/or food product in the vessel.

The opening of the vessel allows the drive mounting to be connected to the drive of the food processor through this opening. This allows a flow-generating section of the flow generator to be placed inside the vessel.

The flow field may be formed within the vessel such that air is accelerated from the flow generator toward a bottom of the vessel, deflected upward from the bottom, and returned to a top of the flow generator after flowing against the at least one food product.

A drive is to be understood as a/an means/element driven by a power machine or a motor, which is suitable for transmitting the power generated by the power machine. The motion of the drive can, for example, be a rotary or reciprocating motion.

The flow generator provides a first function of the food processor. According to the invention, the first function is the generation of a flow field for flowing against the at least one food product.

It may be provided that the drive is configured to set at least one further preparation tool in motion, in particular with a drive mounting, to provide a second function. This may extend the functionality of the food processor while reducing the cost to the user.

It may be provided that the at least one further preparation tool is designed/configured to grind and/or mix and/or stir and/or knead and/or slice the at least one food product.

It may further be provided that the flow generator can be placed on the further preparation tool, in particular on a drive mounting of the further preparation tool and/or a knife, and can be connected thereto, whereby the flow generator can be set in rotation via the drive mounting of the further preparation tool and the drive of the food processor.

The second function can in particular be functions which can be provided by a stirring knife as a preparation tool, i.e. e.g. cutting, chopping, stirring, pureeing etc. In this context, the turbulence of the air generated by a stirring knife or similar tools is not to be regarded as a flow field in the sense of the invention.

It may be provided that the food processor comprises the further preparation tool, in particular a mixing knife. The further preparation tool may be configured to be detachably connectable at least to the drive or the vessel.

It is also conceivable that the food processor has a base in which the drive is arranged, the vessel being detachably connected to the base. The detachable connection between the vessel and the base makes the food processor particularly flexible to use. In particular, the vessel can thus be easily cleaned.

It may be provided that the vessel has a lower opening configured to receive a drive mounting. Such a design/configuration makes it particularly easy to change the preparation tools and thus to use the food processor as a whole.

The food processor according to the invention offers the advantage that by combining the heatable vessel with the flow generator by flowing hot air to the food product, the function of the food processor can be supplemented with a deep frying or baking function. The integration of the heater in the bottom of the vessel also improves safety, as it is unlikely to be accidentally touched from above. If a function other than deep frying is desired, the detachable connection of the drive mounting makes it possible to switch to a further preparation tool if necessary. In addition, since no separate, stand-alone device is needed for deep frying, cost savings for users are possible.

It is conceivable in the food processor according to the invention that the flow generator further comprises a drive mounting configured to be detachably connected to a drive of the food processor and to transmit a motion of the drive, and/or an impeller connected to the drive mounting, the impeller being configured to be set in motion by the drive via the drive mounting, thereby generating a flow field within the heatable vessel.

A drive mounting is a geometrically shaped body that is designed/configured to absorb a force acting on it, whereby the drive mounting can be set in motion. In particular, the motion can be a rotation. However, it may also be provided, for example, that the motion is a reciprocating motion. The drive mounting may be designed/configured as a shaft, in other words as an elongated cylindrical and rotating machine element that serves to transmit rotary motion and torque. Alternatively, the drive mounting may be designed/configured as a connecting rod.

In other words, the flow generator can be provided with an impeller. The flow generator can be understood as a moving, in particular rotating, part of a turbomachine, which supplies energy to a flowing fluid, in particular air, and thereby sets the fluid in motion. The motion may be any motion suitable for setting the air in motion to generate a flow. Further details and variations of the impeller are described below.

The motion of the impeller generates a flow field. In other words, the impeller generates a flow of air through its motion. In the following, the term upstream is used to describe a position upstream of the impeller in the direction of flow. Correspondingly, the term downstream is intended to describe a position in the direction of flow downstream of the impeller.

It can be provided that the impeller is designed/configured to be able to run at a rotational speed of at least 2000, in particular 3000, revolutions per minute. This allows the flow field to be adjusted particularly well.

Furthermore, it is conceivable in a food processor according to the invention that at least the impeller or the drive mounting is free of electrical (also called: electrically free or purely mechanical) components, in particular free of a flow heater. In other words, it can be provided that at least the impeller or the drive mounting comprise no electrical components (or only purely mechanical components), and in particular no heating wire or the like is provided. This has the advantage that the flow generator can be designed/configured to be less sensitive, in particular to corrosion.

It may be provided that the flow generator is designed/configured to be cleanable in a dishwasher. For this purpose, it can be provided that the flow generator has no electronic components, as described above. Alternatively, however, the electrical components may be encapsulated (by a plastic and/or potting compound). Furthermore, the flow generator can have a material, in particular a plastic or a (stainless) steel, at least on an outer surface, which is suitable for cleaning in the dishwasher. This simplifies handling of the flow generator.

Furthermore, it is conceivable in a food processor according to the invention that a separator impeller is provided, which is preferably arranged upstream (or spatially above or above) the impeller and is configured to separate suspended matter contained in the air. In other words, another impeller may be arranged upstream of the impeller to separate particles contained in the flowing air from the air. This is done essentially by centrifugal forces acting on the suspended matter. By providing a separator impeller, the advantage can be achieved that suspended matter do not reach the impeller or other downstream parts, such as a heater. Suspended solids can negatively affect the running ability of the impeller or, for example, heat up strongly on the heater, which can lead to unpleasant odors. Furthermore, the separator impeller may also be designed/configured to assist the flow generation of the impeller by accelerating air in the downstream direction of the impeller.

It may be provided that the impeller is of multi-stage design/configuration, with the separator impeller forming a further, upstream stage to the impeller which is designed/configured for generating the flow field. Furthermore, a fixed guide wheel can be arranged between the separator impeller and the impeller. This offers the advantage that the flow can be configured upstream of the impeller to increase the efficiency of the impeller.

Preferably, in a food processor according to the invention, it can be provided that the separator impeller is connected to at least the impeller or the drive mounting (variably detachably or fixedly), wherein in particular a transmission ratio is provided by which a rotational speed of the separator impeller can differ or vary from a rotational speed of the impeller. By connecting the impeller or drive mounting to the separator impeller, the advantage is achieved that both wheels can be moved in a simple manner, as it were, by (only) one drive of the food processor. This saves costs for additional drives.

A transmission ratio between the impeller and the separator impeller allows the rotational speeds of the impellers to be set independently of each other. Depending on the design/configuration of the separator impeller or on which suspended particles or particulates are present in the air, a different rotational speed of the separator impeller from that of the impeller may be more suitable for separating suspended particles. The suspended particles or particulates can be in particular grease and/or food residues.

It may further be provided in a food processor that at least one diameter or height of the drive mounting is selected to correspond to at least one diameter or height of a drive mounting of a further preparation tool, the preparation tool being configured to provide a function other than providing flow. In other words, the drive mounting may be configured in its geometric dimensions to correspond to a drive mounting that is part of a preparation tool that provides a function other than accelerating air to flow. This has the advantage that users can easily replace the flow generator with a further preparation tool, in particular a mixing knife tool, without the need for a complicated modification to the food processor. This further saves costs and also space in the kitchen (for further equipment).

It can be provided that at least one receiving section of the drive mounting, which is designed/configured to be connected to the drive, in particular mechanically, is designed/configured to be compatible, in particular geometrically identical, to a corresponding receiving section of a preparation tool with a further function. In this way, the advantage can be achieved both that the flow generator can be easily exchanged with a further preparation tool and that certain design/configuration freedoms still remain with respect to the drive mounting.

Within the scope of the invention, it is further conceivable that at least the drive mounting or the impeller comprises metal and/or plastic, and preferably that the drive mounting is essentially molded from a metal, in particular from a steel, and/or that the impeller is essentially molded from a plastic, in particular from a thermoplastic. Here, by substantially is meant at least half, in particular to a proportion of more than 90%. It can also be provided that the drive mounting or the impeller is almost entirely produced from a metal or a plastic. With regard to the drive mounting, metal offers the advantage that the component is mechanically stable so that it can withstand high loads in the case of a strong drive. Steel, in particular stainless steel, shares these good mechanical properties and also exhibits high corrosion resistance, so that the drive mounting can be cleaned easily, in particular in a dishwasher.

Furthermore, in a food processor according to the invention, it is conceivable that the impeller further comprises at least one of the following components:
An impeller cover with an opening through which air can enter the impeller,
An impeller bottom designed/configured to restrict the flow of air through the impeller,
At least one impeller blade designed/configured to accelerate air, wherein in particular the at least one impeller blade is arranged between the impeller cover and the impeller bottom,
A connection section which is designed/configured to connect the impeller to the drive mounting, in particular in a detachable manner.

It can be provided that the diameter of the impeller cover essentially corresponds to the diameter of a basket in which the at least one food product to be prepared is held. This improves the flow of the food products.

Furthermore, it may be provided that the drive mounting protrudes at least partially through the opening of the impeller cover. This results in a guiding effect on the flow, which improves the flow of air into the impeller.

The impeller bottom can be designed/configured both with and without at least one opening. The provision of openings offers the advantage that the impeller or the flow generator can be cleaned more easily overall, in particular in a dishwasher, since cleaning agent can be better distributed through at least one opening. Furthermore, the impeller can be produced with less material, which saves costs. A full-surface impeller bottom offers the advantage of improved mechanical stability and also prevents the formation of a flow around the impellers. This further increases the efficiency of the impeller.

The at least one impeller blade can be arranged in particular between the impeller cover and impeller bottom, resulting in particularly high mechanical stability. However, it is also possible for the at least one impeller blade to be arranged only on one impeller cover or impeller bottom. By omitting an impeller cover or impeller bottom, material costs can be saved.

It may be provided that at least two, in particular all, of the above-mentioned components of the impeller are made in one piece (and/or of the same material). This further improves the mechanical stability of the impeller.

It can also be provided that the impeller or at least one, in particular all, of the above components can be manufactured by injection molding, in particular a 2-component injection molding method. This reduces the manufacturing costs of the impeller.

Furthermore, in a food processor according to the invention, it can advantageously be provided that a flow heater is provided, which is designed/configured to heat the air located in the vessel, wherein the flow heater is arranged in particular on the impeller, preferably at least on an impeller cover or on an impeller bottom. In other words, a heater may be arranged on the flow generator to heat the flowing air.

Particularly advantageously, the flow heater can be arranged at a position within the flow generator at which the flow velocity of the air is low, in particular at its lowest. This allows the generated heat to be transferred to the air particularly efficiently.

Furthermore, in a food processor according to the invention, it is conceivable that the drive mounting comprises a seal in order to seal the drive mounting against the vessel. In other words, the drive mounting can have an element which is designed/configured to prevent or at least limit an unwanted transfer of material between the drive mounting and the vessel.

Advantageously, it can be provided that the seal is produced from a plastic, which is in particular suitable for use in a dishwasher. This further simplifies handling of the flow generator.

It is also possible for the seal to be detachably attached to the drive mounting. This allows the seal to be easily cleaned separately or replaced if necessary, so that handling is simplified and costs can be saved.

The base can be electrically connected to the vessel. In this way, the vessel can be electrically controlled, e.g. a heater can be operated in the vessel. Particularly in combination with a heater arranged at the bottom of the vessel, this has the advantage that the heater can be connected particularly easily and inexpensively, since the cables can be designed/configured to be correspondingly short.

Preferably, a food processor according to the invention can be provided with only one drive and/or only one heater, wherein in particular the only one heater is designed/configured as a vessel heater. In other words, a single drive and/or a single heater can be present on the food processor. This reduces the manufacturing costs of the food processor compared to variants with multiple drives or heaters. If the drive or the heater are usable for several preparation tools, the advantage for users is that the food processor can be used for many different functions, which means that fewer kitchen tools are required, which simplifies handling, saves space and also reduces costs.

Preferably, in a food processor according to the invention, it may be provided that the vessel with the flow generator is closable in a substantially airtight manner so that the flow generator generates a circulating air. In other words, it may be provided that the vessel together with the flow generator forms a substantially air-impermeable space, whereby no fresh air is supplied to this space even when a flow is generated by the flow generator. This offers the advantage that less heat is lost, so that the food processor can heat the air more efficiently, which in turn can save costs. For this purpose, a lid, in particular a hinged and or detachable lid, can be provided on the vessel. A lid offers the advantage that, on the one hand, the at least one food product can be easily filled into the vessel and yet an airtight seal can be ensured.

Preferably, in a food processor according to the invention, it may be provided that a basket is provided which is configured to receive and hold the food product at a distance from a vessel wall of the vessel and at least the preparation tool or the further preparation tool. In other words, the food processor may comprise a holder for the at least one food product, which holds the at least one food product at a predefined distance from the flow generator or the further preparation tool. The basket offers the advantage that by spacing the food product away from the vessel walls and the flow generator the flow field can be formed better and thus the flow to at least one food product is improved.

The basket can be designed/configured as a wire mesh, whereby air can penetrate the basket particularly easily, so that the flow of food products is improved. Alternatively or as a supplement, the basket can be formed with holes at least partially over the entire surface. This also enables air to flow, while improving mechanical stability. This can be particularly advantageous in a lower region of the basket.

Further, in a food processor according to the invention, it may be advantageously provided that the basket has a substantially tubular section which is covered by a cap in such a way as to provide a substantially annular opening through which the air flows to the flow generator when the flow generator is driven by the drive. This has the advantage that suspended matter or particles heavier than air are separated from the air upstream of the flow generator. This ensures that these suspended matter or particles do not get into the flow generator or onto the heater.

It may be provided that the tubular section has a length corresponding to at least one third of the height of the basket, in particular at least half of the height of the basket. This can improve the separation effect of the tubular section.

The term “annular” does not necessarily refer to a circular shape. The shape of the opening is determined by the shape of the tube and the cap, which can be cylindrical or spherical, but also rectangular or cube-shaped. The cap, however, is larger than the tubular section, so that between these two parts there is still an opening for the passage of air.

Within the scope of the invention, it is further conceivable that the basket has at least one channel at a bottom section, which is designed/configured to receive suspended matter transported with the air flow, or has an opening, in particular a closable opening, through which suspended matter transported with the air flow can emerge from the basket. In other words, a recess can be provided at the bottom of the basket in which suspended matter or particles can accumulate. Alternatively or in addition, there may also be an opening at the bottom through which the suspended matter or particles can pass or drain away.

The channel provides the advantage that the suspended matter or particles are collected and do not remain in the air flow. The opening offers the advantage that the suspended matter or particles exit the basket at a predetermined location. This simplifies the handling of the food processor.

It is further conceivable in a food processor according to the invention that a collection tray is provided, which is arranged at least above the flow generator or below a basket and is designed/configured to collect suspended matter transported with the air flow. In other words, a collection container can be provided in which suspended matter or particles can accumulate. This prevents them from remaining in the flowing air or coming into contact with the heater.

Further, in a food processor according to the invention, it may advantageously be provided that a lid is provided which is configured to close an upper opening of the vessel, wherein in particular the lid comprises at least:
A lid heater designed/configured to heat the air enclosed in the vessel, or
A ventilation valve configured to maintain a pressure difference between an atmosphere inside the vessel and outside the vessel below a predetermined value.

In other words, an upper closure can be provided on the vessel. This allows the vessel to be closed, making it easier to adjust the flow field generated. In addition, the efficiency of the heating is increased, since less fresh air is supplied.

A lid heater, or a heater arranged in the lid, which makes it possible to heat the air contained in the vessel, offers the advantage that in addition to the air, the at least one food product is also heated, in particular by radiant heat.

It can be provided that the lid heater is supplied with power from the base of the food processor via a line arranged in the vessel. This facilitates handling compared to a separate power connection for the lid.

A ventilation valve to compensate for pressure differences between the vessel contents and the atmosphere prevents an excessively large pressure difference from occurring. A very large pressure difference would necessitate an appropriately designed/configured lid closure, which would incur additional costs.

Furthermore, in a food processor according to the invention, it may advantageously be provided that the flow generator comprises a flow heater designed/configured to heat the air enclosed in the vessel. In other words, a heater may be arranged on the flow generator to heat the flowing air.

Particularly advantageously, the flow heater can be arranged at a position within the flow generator at which the flow velocity of the air is low, in particular at its lowest. This allows the generated heat to be transferred to the air particularly efficiently.

Preferably, a food processor according to the invention may provide that the vessel includes insulation configured to thermally insulate the vessel from the environment surrounding the vessel. In other words, the vessel may be provided with an insulating material, whereby the vessel and its contents have a lower thermal conductivity compared to a vessel without insulation. This further increases the efficiency of the food processor, allowing it to be operated in a particularly cost-effective manner.

For example, the insulation can be designed/configured as a double wall of the vessel, resulting in good thermal insulation with only a slight increase in weight.

It can also be provided that the insulation can be arranged over the vessel. This makes it particularly easy to fit the insulation.

According to a further aspect of the invention, there is provided a method of operating a food processor, wherein the food processor is particularly embodied as a food processor according to the invention, for preparing at least one food product, the method comprising:
Provide a drive in a base,
Detachably connecting a drive mounting of a first preparation tool to the drive,
Connecting the vessel to the base,
Setting in motion a preparation tool having a drive mounting by a drive, thereby providing a first function,
Heating of at least the air located in the vessel by a heater,
Loosening the connection of the drive mounting to the drive,
Detachable connection of a drive mounting of a further preparation tool to the drive, wherein the heater for heating the air located in the vessel is designed/configured as a vessel heater integrated in a bottom of the vessel.

The method steps/stages can be carried out at least partially simultaneously or chronologically one after the other, so that individual steps/stages can be carried out in different sequences.

Thus, the method according to the invention brings the same advantages as have already been described in detail with reference to a flow generator according to the invention and/or a food processor according to the invention.

It can be provided that a deep frying mode is provided for controlling the food processor, which can be activated via a control device on the food processor. The deep frying mode can be designed/configured to control an automatic, in particular recipe-controlled, processing of preparation steps/stages by at least one preparation tool of the food processor. This enables optimal food product-specific preparation.

It is conceivable that in the deep frying mode at least the heating or the flow generator are controlled specifically for the food or depending on the recipe. This makes it possible to increase the quality of processing of the at least one food product and simplify handling.

The control may comprise at least one control parameter. The at least one control parameter may comprise the temperature ranges/ramps and thus the power of the heater, the rotational speed of at least the impeller or the separator impeller, and a time.

Further advantages, features and details of the invention will be apparent from the following description, in which embodiments of the invention are described in detail with reference to the drawings. In this connection, the features mentioned in the claims and in the description may each be essential to the invention individually or in any combination. It schematically shows:

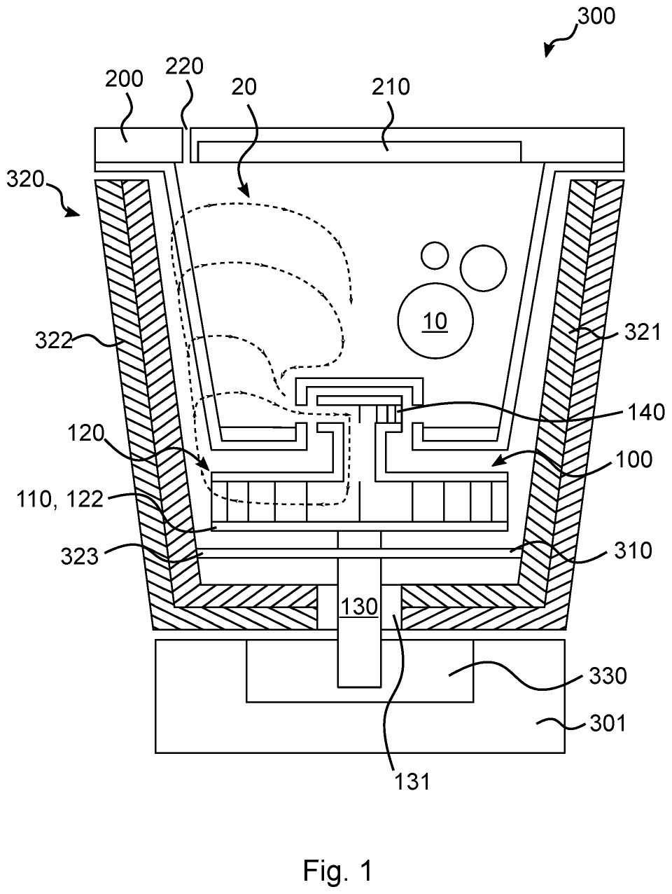

FIG. 1: A side section view of a food processor according to the invention with a flow generator,

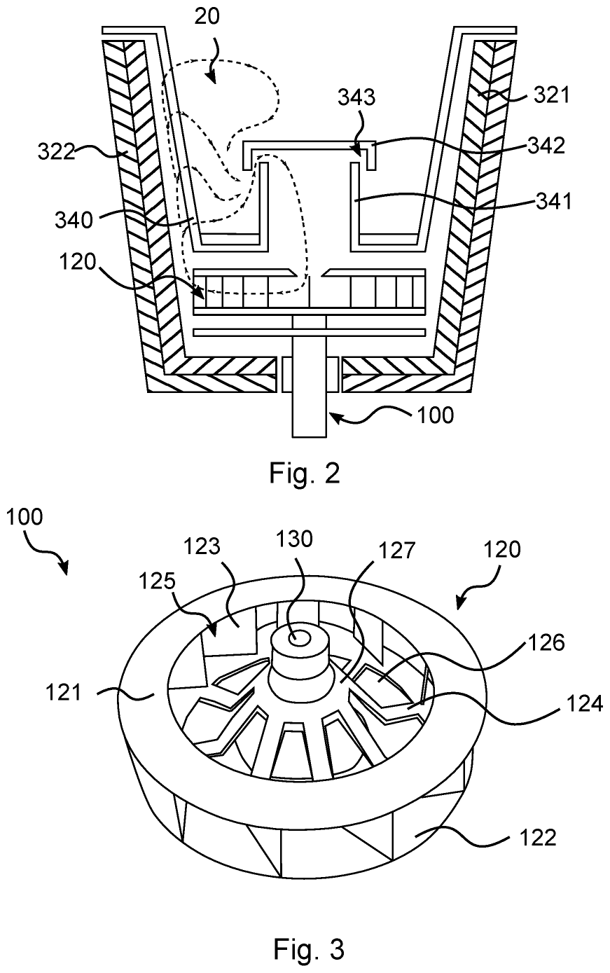

FIG. 2: Another side section view of a food processor according to the invention with a flow generator,

FIG. 3: A perspective view of a flow generator,

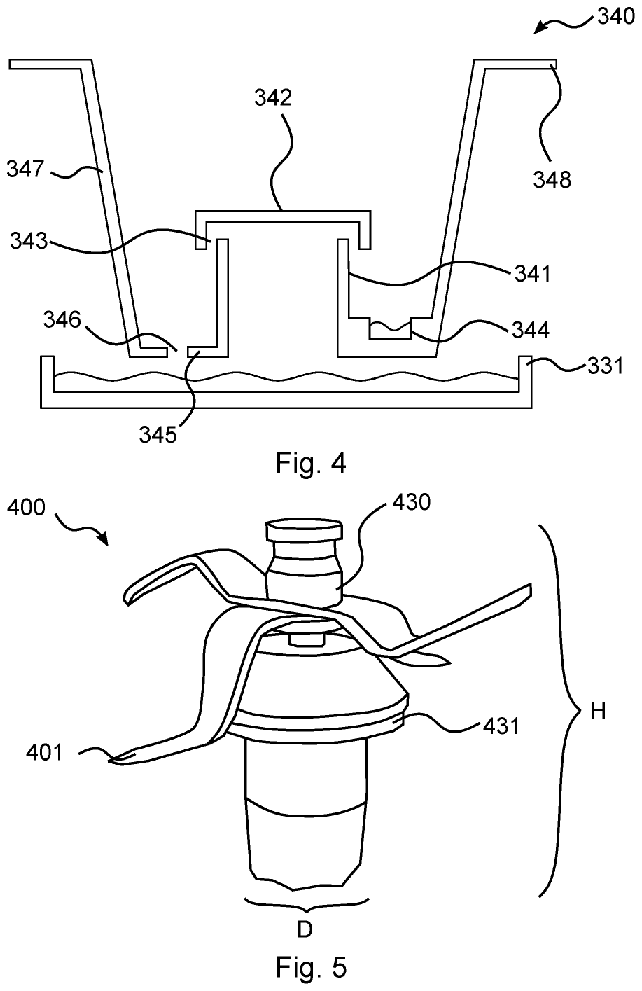

FIG. 4: A side section view of a basket and a collection tray

FIG. 5: A perspective view of a preparation tool, and

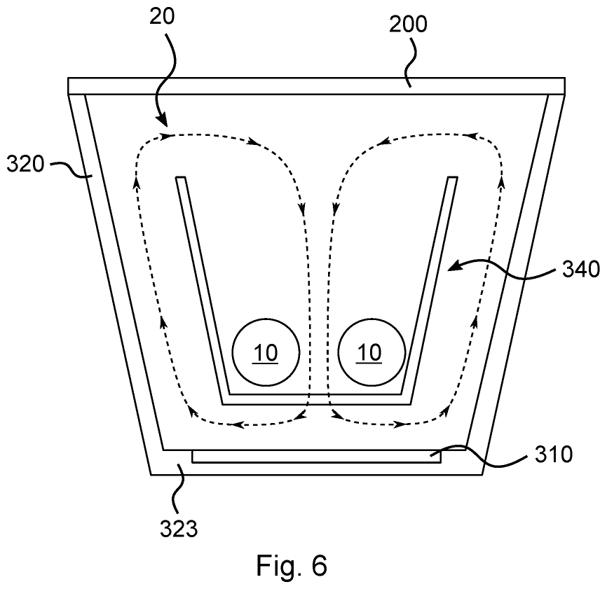

FIG. 6: Another side section view of a part of a food processor according to the invention with a flow generator.

In the following description of some embodiments of the invention, the identical reference signs are used for the same technical features even in different embodiments.

In the figures described below, some features are only partially shown to simplify the presentation and improve comprehensibility.

FIG. 1 shows a food processor 300 comprising a drive 330 configured to cause at least a first preparation tool 100 having a drive mounting 130 to move to provide a first function. The power for the drive 330 may be provided by a motor, in particular an electric motor (not shown here). The drive 330 is arranged to a base 301 of the food processor 300.

Furthermore, it can be seen in FIG. 1 that a vessel heater 310 is provided in a vessel 320. The vessel 320 may have an upper opening 324 through which at least one food product 10 may be introduced into and removed from the vessel. In particular, the vessel 320 may be configured to be removable from the base 301. The vessel heater 310 is configured to heat the air enclosed in the vessel 320, wherein the vessel heater 310 shown in FIG. 1 is integrated into a vessel bottom 323 of the vessel 320.

The illustrated food processor 300 further includes a flow generator 100 for flowing at least one food product 10 with air within the heatable vessel 320. The flow generator 100 has a drive mounting 130 configured to be detachably connected to a drive 330 of the food processor 300 and to transmit motion of the drive 330. Further, the flow generator 100 has an impeller 120 connected to the drive mounting 130, the impeller 120 configured to be imparted in motion by the drive 330 via the drive mounting 130, thereby creating a flow field 20 within the heatable vessel 320.

As can be seen in FIG. 1, the flow of the flow field 20 extends from the impeller 120 toward a lateral vessel wall 321 and is deflected upwardly therefrom to finally flow toward the center of the vessel 320. There is usually the at least one food product 10 which is to be flowed with the heated air. For simplicity, only one half of the flow field 20 is shown here. The at least one food product 10 may be disposed in a basket 340 (not shown here), which will be described in more detail in connection with FIG. 4.

Provision may be made for the vessel 320 to be substantially sealable in an airtight manner with the flow generator 100, such that the flow generator 100 generates recirculating air. In other words, recirculating air operation of the food processor may be provided.

At least the impeller 120 or the drive mounting 130 can be designed/configured free of electrical components, in particular free of a flow heater 110. As a result, the impeller 120 and the drive mounting 130 can be easily cleaned, even under water or in a dishwasher, and are also inexpensive to manufacture.

As shown in FIG. 1, a separator impeller 140 may be provided that is disposed upstream of (or spatially above) the impeller 120 and configured to separate airborne suspended matter. As shown, air within the flow field 20 flows through an opening in the basket 340 to the separator impeller 140 after flowing into the at least one food product 10. Centrifugal forces generated in the separator impeller 140 cause suspended particles and particulates to be ejected from the separator impeller 140 and separated from the air and may accumulate at a bottom of the basket 340.

In other words, the separator impeller 140 serves as an element that prevents grease and/or cooking debris from getting onto the heater 110, 210, 310. If grease and/or cooking debris is deposited on the heater 110, 210, 310, unwanted burns may occur on the heater 110, 210, 310. To prevent this, the air in the flow field 20 and particles as well as liquids (e.g. grease) are separated. The separator impeller 140 corresponds to a rotating suction that separates grease and other particles as well as liquids by centrifugal forces. Specifically, the air circulating in the vessel 320 is thus sucked into a kind of rotating nozzle radially in the direction of its axis of rotation. In this process, the centrifugal force counteracts the motion of the air and liquids (e.g., grease) or particles of greater density than air that are not intended to come into contact with the heater 110, 210, 310 are separated radially outwardly.

It may be provided that the separator impeller 140 is connected to at least one of the impeller 120 and the drive mounting 130, in particular providing a transmission ratio by which a rotational speed of the separator impeller 140 may differ from a rotational speed of the impeller 120. In other words, the separator impeller 140 may also be implemented by means of a transmission ratio between the impeller 120 and the separator impeller 140 to combine the optimal operating points of the impeller 120 and the centrifugal force-based separation.

Furthermore, it can be provided that at least a diameter D or a height H of the drive mounting 130 is selected in such a way that these correspond at least to a diameter D or a height H of a drive mounting 130 of a further preparation tool 400 (as shown, for example, in FIG. 5), wherein the preparation tool 400 is designed/configured to provide a function other than the provision of flow. This results in an easier handling of the food processor and at the same time in a usability enhancement, since several different functions are available. Furthermore, in a food processor 300 according to the invention, it is conceivable that the drive mounting 130 comprises a seal 131 to seal the drive mounting 130 against the vessel 320 and/or the base 301 of the food processor 300.

As can be seen in FIG. 1, a food processor 300 may include a lid 200 configured to close an upper opening of the vessel 320. The upper opening of the vessel may be configured to load and unload food products 10 into and from the vessel 320. It may be provided that the lid 200 may include at least one of a lid heater 210 configured to heat air enclosed within the vessel 320, or a ventilation valve 220 configured to maintain a pressure difference between an atmosphere within the vessel 320 and outside the vessel 320 below a predetermined value. Alternatively, or in addition to the ventilation valve 220, the lid may not close completely airtight so as to allow air exchange between the ambient air and the air in the vessel 320, thereby allowing a pressure differential between an atmosphere in the vessel 320 and outside the vessel 320 to be equalized.

It may further be provided that the vessel 320 includes insulation 322 configured to thermally insulate the vessel 320 from the environment surrounding the vessel 320. In the embodiment shown in FIG. 1, the insulation 322 substantially completely surrounds the vessel 320, particularly at the side wall 321 and at the vessel bottom 323. The insulation 322 results in improved efficiency of the food processor 300 or the heater 110, 210, 310, as less heat from the heated air is lost to the environment.

Even though a flow heater 110, a lid heater 210 and a vessel heater 310 are shown in FIG. 1, it may be provided that only one heater 110, 210, 310, which in particular is designed/configured as vessel heater 310, is provided. Likewise, only one drive 330 may be provided. In this way, the manufacturing costs of the food processor 300 can be reduced.

With reference to FIG. 2, an alternative or supplementary possibility for the separation of suspended particles and particulates is explained. In this variant, the air is sucked vertically upwards and thus against the force of gravity in order to separate particles and liquids of higher density. The gravity used for separation is constant, in contrast to the rotational speed-dependent centrifugal separation. The advantage of this gravity separation is in particular the simple design/configuration.

To this end, the basket 340 may be provided with a substantially tubular section 341 covered by a cap 342 such that a substantially annular opening 343 is formed through which air flows to the flow generator 100 when the flow generator 100 is driven by the actuator 330.

Further precautions could also be taken for separation. These are shown in FIG. 4. There can be provided at least one basket 340 designed/configured as a metal grid, which is arranged in particular between the at least one food product 10 and the impeller 120, a collection tray, which is arranged on the impeller 120 (not shown here), a channel 344 on the basket 340, a flow labyrinth arranged in particular on the essentially tubular section 341 or a collection tray 331, which is arranged below the basket 340. Furthermore, a basket opening 346 can also be provided, through which grease can drain downwards, where it can be collected in particular by the collection tray 331.

The basket 340 according to FIG. 4 has lateral basket walls 347, which can be designed/configured to be less penetrable, in particular for air, than a bottom section 345 of the basket 340. On the one hand, the lateral basket walls 347 serve in connection with the bottom section 345 to receive the at least one food product 10. On the other hand, the lateral basket walls 347 can also be used to shape the flow field 20.

Further, as also shown in FIG. 4, an upper basket section 348 may also be provided. This can be designed/configured in such a way that it can be placed on the vessel 320. Through this, the basket 320 hangs in the vessel 320, in particular without touching the vessel bottom 323 or a collection tray 331.

Referring again to FIG. 3, a flow generator 100 comprising an impeller 120 and a drive mounting 130 is shown. It may be provided that the impeller 120 further comprises at least one of the following:
An impeller cover 121 having an opening 125 through which air can flow into the impeller 120,
An impeller bottom 122 configured to restrict the flow of air through the impeller 120,
At least one impeller blade 123 configured to accelerate air, wherein in particular the at least one impeller blade 123 is disposed between the impeller cover 121 and the impeller bottom 122,
A connection section 127, which is designed/configured to connect the impeller 120 to the drive mounting 130, in particular in a detachable manner.

It may be provided that the diameter of the impeller cover 121 substantially corresponds to the diameter of a basket 340 in which the at least one food product 10 is held. This improves the flow of the at least one food product 10.

Furthermore, it may be provided that the drive mounting 130 protrudes at least partially through the opening 125 of the impeller cover 121. This results in a guiding effect on the flow, which improves the flow of air into the impeller.

The impeller bottom 122 may be formed with or without at least one opening 126. The provision of openings 126 offers the advantage that the impeller 120 or the flow generator 100 is easier to clean overall, in particular in a dishwasher, since cleaning agent can be better distributed through at least one opening. Further, the impeller 120 can be produced with less material, thereby saving costs. A full-surface impeller bottom offers the advantage of improved mechanical stability and also prevents a flow from forming around the impellers. This can further increase the efficiency of the impeller. In particular, eight openings can be provided, as shown.

It may further be provided, as shown, that the impeller bottom 122 includes an outer annular portion configured to support the impeller blades 123. The annular section is connected by web-like supports to a connection section 127, wherein the connection section 127 is configured to be connected to the drive mounting 130. A detent and/or clip connection may be provided for this purpose, thereby improving operability by the user.

The at least one impeller blade 123 can be arranged in particular between impeller cover 121 and impeller bottom 122, resulting in particularly high mechanical stability. However, it is also possible for the at least one impeller blade 123 to be arranged on only one impeller cover 121 or impeller bottom 122. By omitting an impeller cover 121 or impeller bottom 122, material costs can be saved.

It may be provided that at least two, in particular all, of the above-mentioned components of the impeller 120 are made in one piece (and/or of the same material). This further improves the mechanical stability of the impeller 120.

Furthermore, in a food processor 300 according to the invention, it may be provided that the drive mounting 130 is substantially formed of a metal, in particular of a steel, and/or that the impeller 120 is substantially formed of a plastic, in particular of a thermoplastic.

FIG. 5 shows an example of a further preparation tool 400 in the form of a stirring knife 400. This can have at least one, in particular four, knifes 401. Furthermore, the preparation tool 400 has a drive mounting 430, the height H or diameter D of which corresponds at least to the corresponding dimensions of the drive mounting 130 of the flow generator 100. This ensures in particular the easy interchangeability of the preparation tools 100, 400. Furthermore, the further preparation tool 400 may also comprise a seal 431 which ensures a seal of the vessel contents with respect to the base 301 of the food processor 300. In particular, this seal 431 may be arranged in an annular shape around the drive mounting 430.

Looking at FIGS. 3 and 5 together, it is clear that both the flow generator 100 and the further preparation tool 400 can be directly driven by the drive 330 of the food processor 300 via the drive mounting 130, 430.

It may further be provided that the flow generator 100 can be placed on and connected to the further preparation tool 400, in particular to the drive mounting 430 and/or the knife 401, whereby the flow generator 100 can be set in rotation via the drive mounting 430 and the drive 330 of the food processor.

FIG. 6 shows a flow field 20 in which the basket 340 and the vessel 320 create a lateral airflow, with the air being driven through the flow generator 100. Through the airflow, air heated by the vessel heater 310 is directed from above onto the at least one food product 10. It may be provided that the basket 340 has at least fewer, smaller (than at the bottom) or no openings at the lateral basket walls 347 for this purpose, in order to guide the flow upwards between the basket 340 and the vessel 320. By directing the air laterally, the advantage is achieved that additional flow is generated by convection, thereby requiring less energy for the flow generator 100 and also less noise is emitted by the food processor 300.

The foregoing explanation of the embodiments describes the present invention exclusively in the context of examples. Of course, individual features of the embodiments can be freely combined with each other, provided that this is technically reasonable, without leaving the scope of the present invention.

### LIST OF REFERENCE SIGNS

10 Food product

20 Flow field

100 Flow generator, preparation tool

110 Flow heater

120 Impeller

121 Impeller cover

122 Impeller bottom

123 Impeller blade

125 Opening

126 Opening

127 Connection section

130 Drive mounting

131 Seal

140 Separator impeller

200 Lid

210 Lid heater

220 Ventilation valve

300 Food processor

301 Base

310 Vessel heater

320 Vessel

321 Vessel wall

322 Insulation

323 Vessel bottom

324 Upper opening

330 Drive

331 Collection tray

340 Basket

341 Tubular section

342 Cap

343 Opening

344 Channel

345 Bottom section

346 Basket opening

347 Lateral basket wall

348 Upper basket section

400 Further preparation tool

401 Knife

430 Drive mounting

431 Seal

D Diameter

H Height

1. A food processor for preparing at least one food product, comprising:
a drive configured to set at least one preparation tool in motion,
a preparation tool configured as a flow generator for flowing air in the vessel against the at least one food product,
a vessel configured to receive the at least one food product,
wherein the vessel comprises a vessel heater configured to heat the air enclosed within the vessel, the vessel heater being integrated into a bottom of the vessel.

2. The food processor according to claim 1,
wherein
the flow generator further comprises at least
a drive mounting configured to be detachably connected to a drive of the food processor and to transmit motion of the drive, or
an impeller connected to the drive mounting,
wherein the impeller is configured to be imparted in motion by the drive via the drive mounting, thereby creating a flow field within the heatable vessel.

3. The food processor according to claim 1,
wherein
at least the impeller or the drive mounting is free of electrical components.

4. The food processor according to claim 1,
wherein
a separator impeller is provided.

5. The food processor according to claim 4,
wherein
the separator impeller is connected to at least the impeller or the drive mounting.

6. The food processor according to claim 1,
wherein
the impeller further comprises at least one of the following components:
an impeller cover with an opening through which air can flow into the impeller,
an impeller bottom configured to restrict the flow of air through the impeller,
at least one impeller blade configured to accelerate air,
a connection section, which is configured to connect the impeller to the drive mounting.

7. The food processor according to claim 1,
wherein
at least only one drive or only one heater (110, 210, 310) are provided.

8. The food processor according to claim 1,
wherein
the vessel is sealable to the flow generator in a substantially airtight manner such that the
flow generator generates circulating air.

9. The food processor according to claim 1,
wherein
a basket is provided, which is configured to receive the at least one food product and to keep it spaced apart from a vessel wall of the vessel and also at least the preparation tool or the further preparation tool.

10. The food processor according to claim 9,
wherein
the basket has a substantially tubular section which is covered by a cap such that a substantially annular opening is formed through which the air flows to the flow generator when the flow generator is driven by the drive.

11. The food processor according to claim 9,
wherein
the basket has at least one channel at a bottom section, which is configured to receive suspended matter transported with the air flow, or has an opening through which suspended matter transported with the air flow can emerge from the basket.

12. The food processor according to claim 1,
wherein
a collection tray is provided, which is arranged at least above the flow generator or below
a basket and is configured to collect suspended matter transported with the air flow.

13. The food processor according to claim 1,
wherein
a lid is provided, which is configured to close an upper opening of the vessel comprises at least:
a lid heater configured to heat the air enclosed in the vessel, or
a ventilation valve configured to maintain a pressure difference between an atmosphere inside the vessel and outside the vessel below a predetermined value.

14. The food processor according to claim 1,
wherein
the flow generator comprises a flow heater configured to heat the air enclosed in the vessel.

15. A method of operating a food processor, for preparing at least one food product, the method comprising:
Providing a drive in a base,
Detachably connecting a drive mounting of a first preparation tool to the drive,
Connecting the vessel to the base,
Setting in motion a preparation tool having a drive mounting by a drive, thereby providing a first function,
Heating at least one air located in the vessel by a heater,
Loosen the connection of the drive mounting with the drive,
Detachably connecting a drive mounting of a further preparation tool to the drive,
wherein the heater for heating the air located in the vessel is configured as a vessel heater integrated in a bottom of the vessel.

16. The food processor according to claim 4,
wherein
the separator impeller is arranged upstream of the impeller and configured to separate suspended matter contained in the air.

17. The food processor according to claim 5,
wherein
a transmission ratio being provided through which a rotational speed of the separator impeller can differ or vary from a rotational speed of the impeller.

18. The food processor according to claim 6,
wherein
the at least one impeller blade is arranged between the impeller cover and the impeller bottom.

19. The food processor according to claim 7,
wherein
the only one heater is configured as a vessel heater.
